(19) United States
(12) Patent Application Publication
(10) Pub. No.: US 2003/0216136 A1
(43) Pub. Date: Nov. 20, 2003

(54) Portable storage device for providing secure and mobile information

(75) Inventors: Gerald Francis McBrearty, Austin, TX (US); Shawn Patrick Mullen, Austin, TX (US); Johnny Meng-Han Shieh, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY (US)

(21) Appl. No.: 10/150,004

(22) Filed: May 16, 2002

(51) Int. Cl. H04B 1/38

(52) U.S. Cl. 455/410; 455/411

(57) ABSTRACT

A system and method in which user personalized directories of information are maintained on portable and wireless personal data devices. The personal data devices include a storage medium, a wireless transmitter, and a state machine suitable for implementing a wireless protocol such as Bluetooth or IEEE 802.11b. Typically, the personal data devices are small enough to clip or otherwise attach to a user's clothing. The personal data device is configured to transmit a signal that includes personal data device (PDD) identification information. When the user is within range of a suitably enabled workstation, the workstation “hears” the signal and deciphers the PDD ID. If the user attempts to log on to the network, the workstation will prompt the user for a username/password combination and compare the user's responses to information password and user ID information stored in a table that is accessible to the workstation. If the workstation is able to confirm the user ID and password, it may then perform a second authorization sequence in which the workstation sends a workstation password to the personal data device. The workstation may also send additional information such as a directory that the workstation proposes to use as a mount point. This proposed directory typically specifies the user's personalized directory. If the personal data device is able to confirm the workstation password and the proposed directory as valid, a “connection” is established between the personal data device and the workstation. The workstation is then able to mount the user's directory on the personal data device and provide the user's personal desktop to him or her.

### BACKGROUND

1. Field of the Present Invention

The present invention generally relates to the field of data processing systems and networks and more particularly to a method and system for using a portable data device and wireless technology to implement secure and portable personalized desktop-type functionality.

2. History of Related Art

The concept of a portable desktop is well known in the field of data processing systems and data processing networks. A portable desktop generally refers to a facility that enables a user to recreate their own personal desktop on any machine with which they connect to a network. Implied by the term personal desktop is the private data associated with each user including, for example, email, appointments, personal files, and the like. By enabling users to use a greater number of devices without sacrificing the benefits of a familiar and personalized interface, portable desktops have the potential to expand a network's flexibility greatly. Typically, portable desktops are achieved by storing on the network a personalized file system or directory for each user. In order to enable a user's home directory and desktop to pop up anywhere in a computer cluster, the user's file system or disk must be placed on the network. This model, unfortunately, could lead to security lapses in which, for example, a root system administrator could snoop and read a user's personal email. One attempt to address this problem contemplates distributing a personal data device drive to each user. The user's personal directory is stored on the personal drive. When the user connects to the network using a particular machine, the personal drive is inserted into an appropriate slot of the machine. After “hot plugging” the drive into the machine, a network workstation can mount the personal directory on the personal drive and provide a personalized interface to the user. It will appreciated, however, that the cost and inconvenience associated with requiring users to perform field installs and disk drive configurations every time they wish to access their portable disks makes this solution impractical. It would be desirable, therefore, to implement a system and method that provides the benefits of personalized and portable desktops without sacrificing security and without incurring the cost and inconvenience of requiring each user to carry bulky disk drives that require physical insertion and configuration.

### SUMMARY OF THE INVENTION

The problems identified above are in large part addressed by a system in which user personalized directories of information are maintained on a portable and wireless device referred to herein as a personal data device. The personal data device includes a storage medium, a wireless transmitter, and a state machine suitable for implementing a wireless protocol such as Bluetooth or IEEE 802.11b. The personal data device is configured to transmit a signal that includes personal data device identification (PDD ID) information. When the user is within range of a suitably enabled workstation, the workstation “hears” the signal and deciphers the disk ID. If the user then attempts to log on to the network, the workstation will prompt the user for a username/password combination and compare the user's responses to password and user ID information stored in a table that is accessible to the workstation. If the workstation is able to confirm the user ID and password, it may then perform a second password sequence in which the workstation sends a workstation password to the personal data device. The workstation may also send additional information such as a directory that the workstation proposes to use as a mount point. This proposed directory typically specifies the user's personalized directory. If the personal data device is able to confirm the workstation password and the proposed directory as valid, a “connection” is established between the personal data device and the workstation. The workstation is then able to mount the user's directory on the personal data device and provide a personal desktop to the user. If the user subsequently logs off the system, the personal data device is unmounted. If the user simply walks away from the system with the personal data device without logging off, the workstation will detect the absence of the signal and clear any cached information associated with the personal data device.

### BRIEF DESCRIPTION OF THE DRAWINGS

Other objects and advantages of the invention will become apparent upon reading the following detailed description and upon reference to the accompanying drawings in which:

FIG. 1 is a block diagram of selected features of a data processing network according to one embodiment of the present invention including a workstation and a personal data device;

FIG. 2 is a conceptual representation of a database within the workstation of FIG. 1;

FIG. 3 is a flow diagram of a method of implementing a personalized desktop or directory for users in a data processing network according to one embodiment of the present invention; and

FIG. 4 is a block diagram of selected features of a data processing network according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking the present invention contemplates a system that enables personalized desktop functionality across a computer network without sacrificing security and without requiring a user to install and configure a disk or other storage medium into a computer each time a log-on sequence is initiated. Authorized users are provided with a personal data device that typically includes a storage medium coupled to a radio frequency transmitter as well as a state machine and firmware that implement a wireless networking protocol. The storage medium includes the user's personal directory containing personal data/files including, for example, email, appointments, and the like. The personal data device is preferably sufficiently small to enable users to clip it to their clothing or otherwise carry it on themselves in the same way that a they might wear a cellular telephone or an wireless paging device. When powered on, the personal data device broadcasts a signal identifying the personal data device to prospective listening devices such as a network workstation (the host). If the personal data device is within range of an enabled host, the host will decode the personal data device identifier and determine from a stored database whether the personal data device is a recognized device. If the user then attempts to connect to the network, the host will require the user to perform a log-on sequence in which a user ID and password are entered. If the log-on information entered by the user matches log-on information stored in the appropriate entry of a secure database, which may be located on the workstation itself or elsewhere on the network, the user has successfully authorized himself to the workstation. The workstation will typically then authorize itself to the personal data device by sending an authorization request to the personal data device that includes a workstation password and perhaps a proposed directory name to be mounted. The personal data device compares this information to information stored in the personal data device to determine if the workstation is authorized to communicate with it. If the workstation successfully authorizes itself to the personal data device, a “connection” established and the personal data device will export its file system directory to the workstation, which is then authorized to perform a wireless mount of the user's personal directory. Thereafter, the personal directory is available to the user via the workstation. In this manner, the user's personal directory stays in his or her physical control at all times while security is preserved through the two-way authentication process.

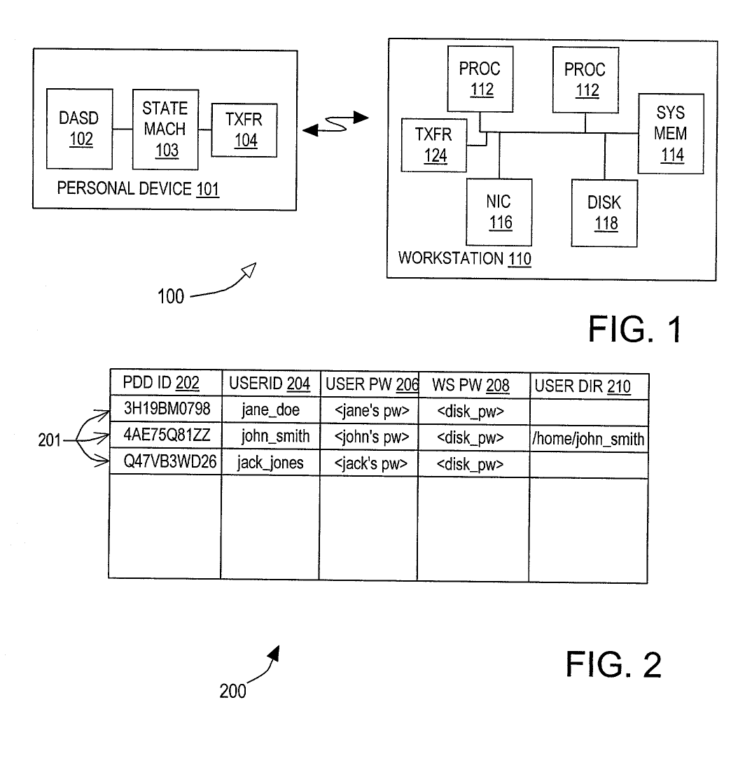

Turning now to the drawings, FIG. 1 is a block diagram of selected elements of a data processing network 100 according to one embodiment of the present invention. In the depicted embodiment, network 100 includes a personal data device (also sometimes referred to as a personal disk device) 101 and a data processing system identified as workstation 110. Personal data device 101 includes some form of direct access storage device (DASD) 102, a wireless transceiver 104, and a state machine 103 that configures transceiver 104 to transmit data to and from DASD 102 according to a predetermined format. Transceiver 104 includes an antenna subsystem and any baseband link control hardware or software needed to implement the selected wireless technology.

State machine 103 may be implemented in hardware, software, firmware, or a suitable combination thereof. In one embodiment, state machine 103 implements the IEEE 802.11b wireless LAN (WLAN) protocol, also referred to as Wireless Fidelity or WiFi, to transmit data via transceiver 104. In other embodiments, a Wireless Personal Area Network (WPAN) protocol such as Bluetooth® may be used.

Bluetooth is a wireless technology developed initially by Ericsson as a short-range cable replacement for linking portable consumer electronic products. Bluetooth is intended to enable the formation of small wireless networks of Bluetooth-equipped products on an ad hoc basis. It overcomes the shortfalls of infrared, namely, lack of range and clear line-of-sight. WiFi is gaining acceptance with original equipment manufacturers (OEMs) such as IBM Corporation. The 802.11b standard is compelling for at least two reasons. It is a more mature technology than Bluetooth and generally offers more range than Bluetooth. Whereas many Bluetooth implementations are limited to 10 meters, WiFi enables wireless connections at ranges approaching 100 meters.

Data processing network 100 as depicted in FIG. 1 further includes a data processing system identified as workstation 110. Workstation 110 is typically implemented as a server-class computer that includes one or more general purpose microprocessors 112 (e.g., PowerPC® processors from IBM Corporation or Pentium® processors from Intel) connected to a volatile system memory 114 that is used to store instructions and data. Workstation 110 typically further includes I/O peripheral devices including, as examples, a hard disk 118 (or other form of persistent mass storage) and a network interface card (NIC) 116, all as will be familiar to those skilled in the field of microprocessor-based data processing systems. In addition, workstation 110 includes a transceiver 124 that is complementary to transceiver 104 of personal data device 101.

In one embodiment, DASD 102 of personal data device 101 is implemented with a nonvolatile storage device such as a flash memory card or small disk while, in embodiments emphasizing performance, DASD 102 may include one or more SRAM devices. In an SRAM embodiment, it will be appreciated that a small standby current is required to maintain data when power is otherwise terminated. Thus, personal data device 101 may include a battery or other source suitable for maintaining a relatively small current to DASD 102 in much the same manner as battery-backed CMOS storage is maintained in conventional desktop systems.

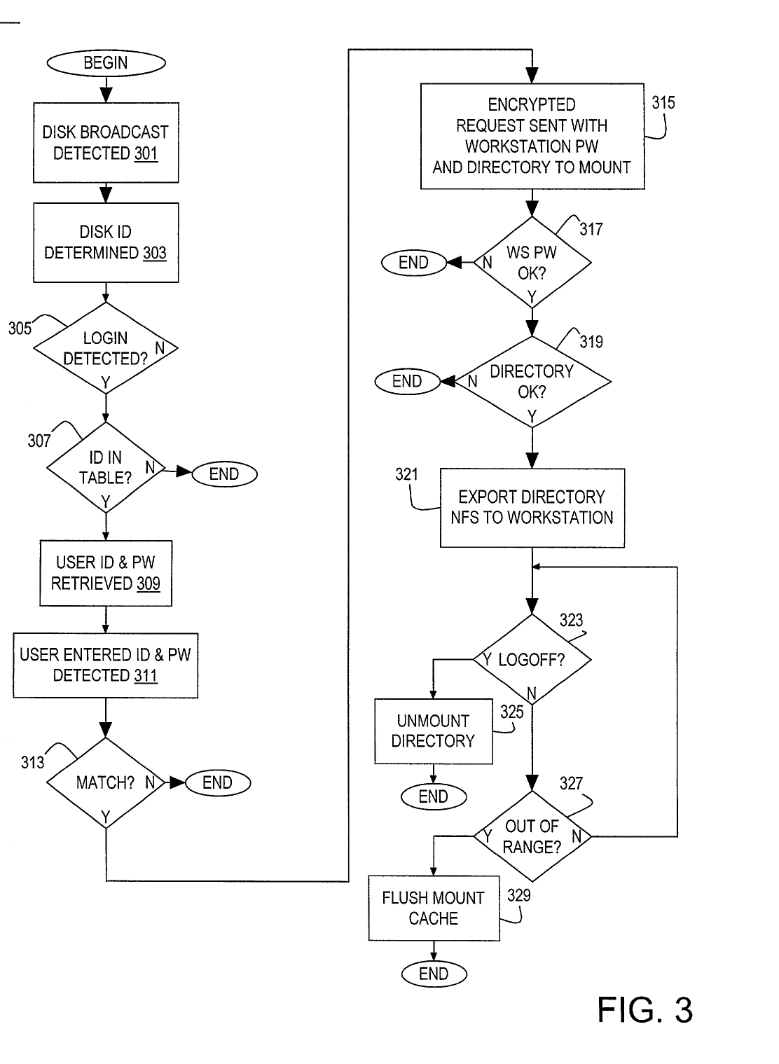

Referring now to FIG. 2, a conceptual illustration of a database maintained in workstation 110 is depicted. Workstation 110 typically includes or has access to a database exemplified by table 200. Table 200 typically includes an entry (row) 201 for each authorized user of the network. Each entry typically includes sufficient information to enable workstation 110 to authenticate a personal data device 110. In addition, each entry 201 of table 200 as depicted further includes additional information that is used to enable the personal data device to authorize the workstation as an authorized workstation. More specifically, each entry in table 200 includes personal data device (PDD) identification information 202, user identification information 204, and a user password 206 that are used by workstation 110 to authenticate personal data devices as well as a workstation password 208 and a user directory 210 that are used by personal data device 101 to authenticate workstation 110 as an authorized workstation. Stored in each personal data device 101 is the data contained in the entry of table 200 corresponding to the personal data device. Personal data device 101 may contain similar data for each workstation or network it is authorized to access.

The transceiver 104 in each personal data device 101 is configured by state machine 103 to transmit a signal that includes its corresponding PDD identification information 202. If a personal data device 101 is in the appropriate range of a workstation 110, the workstation will detect the signal via its transceiver 124. The information transmitted from personal data device 101 and workstation 110 is preferably encrypted according to a predetermined encryption key to decrease the probability of unauthorized interception and decoding of the information. In such a case, workstation 110 is configured to decrypt the signal and determine the PDD identification information transmitted by personal data device 101. To address a scenario in which multiple personal data devices are within range of the workstation, workstation may be configured to decrypt or otherwise determine the PDD identification information 202 of just one of multiple signals it receives. If the owner of personal data device 101 subsequently attempts to log on to or otherwise connect to the network associated with workstation 110, a two-way authorization sequence is initiated. One embodiment of this authorization sequence is depicted in the flow diagram of FIG. 3, which will be referred to in the following description.

Initially, as described above, personal data device 101 broadcasts a signal containing the personal data device's PDD identification information, typically in an encrypted format. If personal data device is within range of an enabled workstation or other listener, the signal is detected (block 301) and deciphered (block 303) by the transceiver 124 of workstation 110. Workstation 110 will typically then wait until a log-on is initiated by the user before taking further action.

If a log-on sequence is subsequently detected (block 305) by workstation 110, it will use the PDD identification information to determine (block 307) if there is a matching entry in its table 200. If workstation 110 cannot locate an entry having the correct PDD identification information 202, the log-on sequence is aborted and no access is granted to the user. If the PDD identification information matches an entry in table 200, workstation 110 will retrieve (block 309) other information from the matching entry including the user identification information 204 and the user password information 206 and prompt the user to enter identification and password information. Workstation 110 will then detect (block 311) the user identification and password information entered by the user. If a match is detected (block 313) between the user-entered information and the corresponding information contained in table 200, the user has successfully authorized itself to the workstation. In the depicted embodiment, however, a second authorization sequence is executed in which the workstation authorizes itself to personal data device 101. If the user-entered identification and password information does not match the stored information, workstation 110 will terminate the log-on sequence and deny access to the user (perhaps giving the user a predetermined number of attempts to try the sequence again).

To authorize itself to personal data device 101, workstation 110 will then send (block 315) an encrypted request to personal data device 100, using the PDD identification information to ensure that any other personal data devices in the vicinity do not respond. In one embodiment, the workstation request will include workstation password information 208 and directory information 210 from table 200. If (blocks 317, 319) personal data device 101 does not recognize either the workstation password 208 or the directory identifier 210, the log-on sequence is terminated by the personal data device thereby preventing the presumable unfamiliar workstation from accessing the user's personal information.

If the authorization of workstation 110 by the user completes successfully, the personal data device 101 then exports (block 321) the directory to workstation 110 to provide the workstation with a mount point. In a typical embodiment, a Network File System (NFS) directory is used. After the directory is exported to workstation 110 and mounted, the user of personal data device 101 is granted access to the network and is provided with his or her personalized desktop including, for example, the user's email files, calendar files, and any preferences the user might have entered.

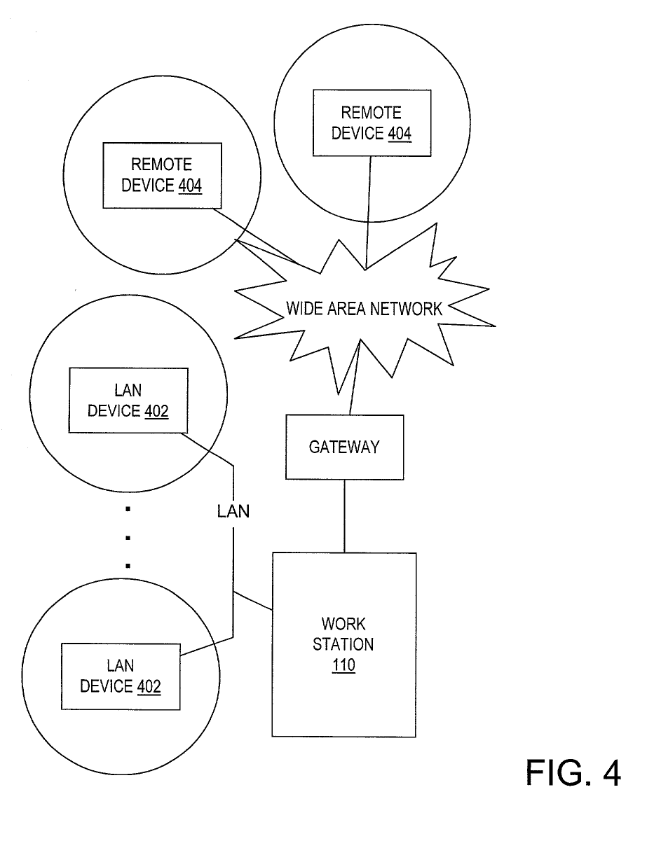

The network will maintain this connected state until one of two events occurs. If (block 323), a log out sequence is initiated by the user and detected by workstation 110, the workstation will unmount (block 325) the user's personal directory as part of the log off sequence. If no log off is detected (block 327), but the personal data device leaves the vicinity of workstation 110 such as if the user walks away from the network, an unmount procedure cannot be completed, but workstation 110 can clear (block 329) the mount cache to prevent unauthorized accessing of this information. Throughout this disclosure, only two entities of the network were relevant, namely, the personal data device 101 and the workstation 110. This technology, however, can be extended across the network by employing network devices configured with suitable wireless capability. Referring now to FIG. 4, an embodiment of the present invention in which network devices identified as LAN devices 402, which are connected to a common LAN with workstation 110, and remote devices 404, which are connected to workstation 110 through an intermediate gateway and wide area network such as the Internet, are configured with the appropriate wireless technology in the form of a transceiver such as transceiver 124 of workstation 110. With this configuration, each LAN device 402 and remote device 404 is configured to detect a personal data device 101 within its range. The RF range of each network device is shown conceptually as circles around each device. In this implementation, a user does not necessarily have to be within the RF range of workstation 110, but only in range of a device connected to workstation 110 that includes the appropriate wireless technology.

It will be apparent to those skilled in the art having the benefit of this disclosure that the present invention contemplates a system for providing a personalized desktop in a network environment using wireless technology and a secure authorization sequence. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A data processing configuration, comprising:
a portable personal data device including a storage element, a radio frequency transceiver, and a state machine suitable for implementing a wireless protocol enabling transmission and receipt of data via the transceiver, wherein the storage element includes desktop data personal to a corresponding user and wherein the personal data device is configured to transmit, via the transceiver, a wireless signal identifying the personal data device;
a host workstation including at least one processor connected to a volatile system memory, a transceiver suitable for receiving the wireless signal and for determining the personal data device identifying information;
means for securely accessing a database containing an entry for each of the at least one personal data devices, wherein each entry includes personal data device identification and password information;
workstation means for determining if the wireless signal is being transmitted by a recognized personal data device;
responsive to recognizing the personal data device, means for authorizing a wireless connection between the personal data device and the workstation;
responsive to successfully authorizing the connection, workstation means for wirelessly accessing the personal data stored on the personal data device to enable the user to access the personal data via the workstation.

2. The configuration of claim 1, wherein the portable personal data device is configured for removable attachment to the user's clothing.

3. The configuration of claim 1, wherein the wireless protocol is selected from the group including an IEEE 802.11b protocol and a Bluetooth protocol.

4. The configuration of claim 1, wherein the host information includes a host password and wherein the storage element includes at least one entry, wherein each stored entry contains a corresponding host password and further wherein the means for verifying the host information includes means for comparing the received host password to the host password in each entry in the storage element.

5. The configuration of claim 4, wherein the host information further includes a host-proposed directory path and wherein the means for verifying the host information includes means for comparing the host-proposed directory path to a directory path stored in the storage element.

6. The configuration of claim 1, wherein the means for enabling the host to access the desktop data includes means for providing a directory mount point to the host.

7. The configuration of claim 1, wherein the means for determining a recognized personal data device including means comparing the personal data device identification information determined from the signal to personal data device identification information stored in the database.

8. The configuration of claim 1, wherein the means for authorizing the connection includes;
means for authorizing the user of the personal data device to the workstation; and
means for authorizing the workstation to the personal data device.

9. The configuration of claim 8, wherein the means for authorizing the user includes means for prompting the user to enter password information and means for comparing the entered password information to password information stored in the database.

10. The configuration of claim 8, wherein the means for authorizing the workstation to the personal data device includes means for wirelessly transmitting workstation information from the workstation to the personal data device.

11. The configuration of claim 10, wherein the means for authorizing the workstation to the personal data device further includes means for wirelessly transmitting a workstation proposed directory path to the personal data device wherein proposed directory path represents a directory path the workstation will mount if the connection is authorized.

12. The configuration of claim 1, wherein the means for wirelessly accessing the personal data stored on the personal data device includes means for wirelessly mounting a directory path under which the personal data is stored.

13. A portable personal data device, comprising:
a storage element, a radio frequency transceiver, and a state machine suitable for implementing a wireless protocol enabling transmission and receipt of data via the transceiver, wherein the storage element includes desktop data personal to a corresponding user and wherein the personal data device is configured to transmit, via the transceiver, a wireless signal identifying the personal data device;
means for verifying host information received wirelessly from the host that identifies the host to the portable processing device; and
responsive to verifying the host, means for enabling the host to access the desktop data wirelessly.

14. The device of claim 13, wherein the portable personal data device is configured for removable attachment to the user's clothing.

15. The device of claim 13, wherein the wireless protocol is selected from the group including an IEEE 802.11b protocol and a Bluetooth protocol.

16. The device of claim 13, wherein the host information includes a host password and wherein the storage element includes at least one entry, wherein each stored entry contains a corresponding host password and further wherein the means for verifying the host information includes means for comparing the received host password to the host password in each entry in the storage element.

17. The device of claim 16, wherein the host information further includes a host-proposed directory path and wherein the means for verifying the host information includes means for comparing the host-proposed directory path to a directory path stored in the storage element.

18. The device of claim 13, wherein the means for enabling the host to access the desktop data includes means for providing a directory mount point to the host.

19. A workstation suitable for use with at least one personal data device, the workstation including at least one processor connected to a volatile system memory and further comprising:
a transceiver suitable for receiving a wireless signal transmitted by one of the personal data devices and further suitable for determining information contained in the signal identifying the corresponding personal data device;
means for securely accessing a database containing an entry for each of the at least one personal data devices, wherein each entry includes personal data device identification and password information;
means for determining if the wireless signal is being transmitted by a recognized personal data device;
responsive to recognizing the personal data device, means for authorizing a connection between the personal data device and the workstation;
responsive to successfully authorizing the connection, means for wirelessly accessing the personal data stored on the personal data device to enable the user to access the personal data via the workstation.

20. The workstation of claim 19, wherein the means for determining a recognized personal data device including means comparing the personal data device identification information determined from the signal to personal data device identification information stored in the database.

21. The workstation of claim 19, wherein the means for authorizing the connection includes;
means for authorizing the user of the personal data device to the workstation; and
means for authorizing the workstation to the personal data device.

22. The workstation of claim 21, wherein the means for authorizing the user includes means for prompting the user to enter password information and means for comparing the entered password information to password information stored in the database.

23. The workstation of claim 21, wherein the means for authorizing the workstation to the personal data device includes means for wirelessly transmitting workstation information from the workstation to the personal data device.

24. The workstation of claim 23, wherein the means for authorizing the workstation to the personal data device further includes means for wirelessly transmitting a workstation proposed directory path to the personal data device wherein proposed directory path represents a directory path the workstation will mount if the connection is authorized.

25. The workstation of claim 19, wherein the means for wirelessly accessing the personal data stored on the personal data device includes means for wirelessly mounting a directory path under which the personal data is stored.

26. The workstation of claim 19, wherein the transceiver complies with a wireless protocol selected from the group including IEEE. 802.11b and Bluetooth.
